(19) United States
(12) Patent Application Publication
(10) Pub. No.: US 2024/0119486 A1
(43) Pub. Date: Apr. 11, 2024

(54) DYNAMIC POPULATION OF CONTEXTUALLY RELEVANT VIDEOS IN AN ECOMMERCE ENVIRONMENT

(71) Applicant: Loop Now Technologies, Inc., San Mateo, CA (US)

(72) Inventors: Jerry Ting Kwan Luk, Menlo Park, CA (US); Michael A. Shoss, Milton (CA)

(73) Assignee: Loop Now Technologies, Inc., San Mateo, CA (US)

(21) Appl. No.: 18/377,854

(22) Filed: Oct. 9, 2023

Related U.S. Application Data
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.

(51) Int. Cl. G06Q 30/0241; G06F 16/783; G06Q 30/0273; G06Q 30/0601

(52) U.S. Cl. CPC G06Q 30/0277; G06F 16/783; G06Q 30/0275; G06Q 30/0631

(57) ABSTRACT

Disclosed embodiments provide techniques for dynamic population of contextually relevant videos in an ecommerce environment. A library of short-form videos is accessed from a server, and one or more short-form videos within the library is associated with a product for sale. In cases where a user searches for a product for sale on a website, a short-form video request is received. One or more short-form videos are selected from the library based on the product associations. In some instances, the video selection is optimized based on metadata, a bid from an advertiser, or machine learning. A container unit is inserted into the website and is dynamically populated with the short-form videos. A microsite is generated, enabling an ecommerce purchase. The microsite can use a product card or display a virtual purchase cart while the video plays.

### RELATED APPLICATIONS

This application claims the benefit of U.S. provisional patent applications “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, and “Livestream With Large Language Model Assist” Ser. No. 63/536,245, filed Sep. 1, 2023.

Each of the foregoing applications is hereby incorporated by reference in its entirety.

### FIELD OF ART

This application relates generally to video processing and more particularly to dynamic population of contextually relevant videos in an ecommerce environment.

### BACKGROUND

Since the earliest times, humans have used their senses of taste, smell, touch, hearing, and sight to perceive and interpret the world around them. As civilization has advanced, various methods have been introduced to enhance and stimulate our senses, and to heighten our experiences in diverse ways. For example, simple food preparation has given way to adding various herbs and spices to recipes and employing multiple cooking methods. As trade has expanded, ingredients from other parts of the world have also been introduced. Likewise, music has become more varied and elaborate, with influences from many other cultures and times. The sense of touch has been stimulated with textiles manufactured differently to create subtle changes in the feel of cloth and how it interacts with light. Visual arts have expanded in the use of color and pattern. Artists often combine visual pieces with music, spoken word, or other recorded sounds. In recent years, professionals and amateurs have produced motion pictures and videos at a phenomenal rate and in increasingly sophisticated ways. Computers can be used to draw images with colors and textures simultaneously. Motion pictures are now made using both film and digital recording. Animation has grown from single-pane cartoons to three-dimensional images which are nearly indistinguishable from real life. Pieces of art that were once available only in a museum can now be viewed anywhere, at any time. Their images can be manipulated using software available on a home computer or cell phone. Photographs and videos can be taken and edited on handheld devices relatively quickly.

At the same time, methods of preserving and recording our sensory experiences have emerged. Cooks write down recipes and compile cookbooks; musicians create music scores and recordings using many different techniques; and artists produce paintings, drawings, photographs, and videos which are stored on physical and digital media. Software applications and computer storage systems are now designed to capture, store, and manipulate video recordings. The uses of these videos have diversified and expanded as well. The stimulation of our visual and aural senses has become more purposeful and sophisticated. Government and private companies produce videos to instruct and demonstrate products. Individuals film videos using cell phones or tablets for all sorts of reasons: to remember a special event or place, to demonstrate the latest dance craze, to play songs or recite poetry, to teach, to share, to laugh, or to grieve. Billions of people actively use social media and routinely include digital pictures and recorded videos in everyday communication. In social media systems and other content sharing systems, video, music, and other media files are encoded and transmitted in sequential packets of data so they can be streamed instantaneously. Photos, sound bites, and short-form videos produced worldwide expand our perception immeasurably. The advent of short-form video, in particular, has contributed significantly to the amount of global data on the Internet. As technologies improve and new services are enabled, the amount of global data available and the rate of consumption of that data will only continue to increase.

### SUMMARY

Techniques for dynamic population of contextually relevant videos in an ecommerce environment are disclosed. Online marketing and sales of products and services have increased significantly, expanding the demand for short-form videos related to these products. As a customer investigates products and services on a website, short-form videos related to these items can be provided directly to the website, offering opportunities to purchase these items immediately or place them into a virtual shopping cart for acquisition later. A library of short-form videos is accessed from a server, and one or more short-form videos within the library is associated with a product for sale. In cases where a user searches for a product for sale on a website, a short-form video request is received. One or more short-form videos are selected from the library based on the product associations. In some instances, the video selection is optimized based on metadata, a bid from an advertiser, or machine learning. A container unit is inserted into the website and is dynamically populated with the short-form videos. In some embodiments, a microsite is generated, enabling an ecommerce purchase. The microsite can use a product card or display a virtual purchase cart while the video plays.

A computer-implemented method for video processing is disclosed comprising: accessing from a server a library of short-form videos; associating one or more short-form videos within the library with at least one product for sale; receiving from a website a short-form video request, wherein the request is in response to a search by a user for the at least one product for sale; selecting, from the library of short-form videos, at least one related short-form video, wherein the selecting is based on the associating and wherein the selecting includes the one or more short-form videos; inserting a container unit into the website; and populating, in the container unit, the at least one related short-form video, wherein the populating is accomplished dynamically. Some embodiments comprise optimizing the selecting of the at least one related short-form video. In embodiments, the optimizing is based on metadata. In embodiments, the metadata associated with the related short-form video includes hashtags, repost velocity, user attributes, user history, ranking, product purchase history, view history, or user actions.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dynamic population of contextually relevant videos in an ecommerce environment.

FIG. 2 is a flow diagram for optimizing the selection of contextually relevant videos in an ecommerce environment.

FIG. 3 is an infographic for associating short-form videos with products for sale.

FIG. 4 is a block diagram for optimizing the selection of contextually relevant short-form videos.

FIG. 5 is an infographic for populating a container unit with at least one related short-form video on a website.

FIG. 6 is an infographic illustrating organic, sponsored, and promotional videos within a container unit prioritized by bid.

FIG. 7 shows product card and virtual purchase cart enablement for contextually relevant short-form videos.

FIG. 8 is a system diagram for dynamic population of contextually relevant videos in an ecommerce environment.

### DETAILED DESCRIPTION

Short-form videos made by professionals and amateurs alike are changing how we gather information about products and services. As our society becomes more mobile and electronically connected, the opportunities to inform and persuade customers continue to shift toward multi-media methods. Companies and individuals produce short-form videos using multiple formats and approaches, demonstrating the use of products and related services, comparing their products to competitors, etc. In some cases, endorsements by celebrities and known experts are included, as are instructional videos detailing the uses of products in particular applications. Once created, these digital videos can be edited rapidly and distributed even more quickly. Using various social media platforms, consumers can comment on their experiences with products and companies and share them with others. These comments often take the form of short-form videos as well, greatly expanding the number of videos available to help sell goods and services. Purchases without any in-person interactions with sales representatives or products have become commonplace. Instead, customers routinely make purchase decisions based on information gathered electronically through social media outlets or vendor websites. Thus, managing and associating products and services with targeted short-form videos and distributing them rapidly to potential buyers are vital to a company's success in today's commercial environment.

Techniques for dynamic population of contextually relevant videos in an ecommerce environment are disclosed. First, a repository of short-form videos is assembled. The short-form video collection may be composed of professionally produced videos on behalf of a vendor or group of vendors, short-form video demonstrations or commentaries by users of products, celebrity endorsements, or a combination of these and other related videos. As the collection is brought together, metadata related to the short-form videos is captured. The metadata may include hashtags, user history, ranking, view history, and so on. As the videos are added to the repository, associations are made with one or more products or services for sale. The associations indicate what products or services are highlighted by the short-form videos. The associations can be generated using short-form video metadata or machine learning techniques. In some cases, multiple products or related services may be highlighted by a single video, leading to multiple associations within the repository. Machine learning can also aid in analyzing and categorizing the videos, using additional user data or conversion rate information. User data from the website originating the search can be used to populate needed sales information later in the flow. User data can also update the library's conversion rate information associated with short-form videos. Conversion rates indicate the number of times that viewing a particular video led to a sale and are expressed as a percentage.

As users search for products and services on a website, the search request is passed on to the server managing access to the short-form video collection. The search request can contain stock-keeping unit numbers (SKUs), International Standard Book Numbers (ISBNs), or Global Trade Item Numbers (GTINs), as well as user information including username, address, credit card, previous purchase, etc. which was collected by the website originating the search. This SKU, ISBN, or GTIN data can be passed along to a virtual purchase cart or other ecommerce purchasing process so that inventory can be updated as sales are made. It can also be used to update the conversion rate of a video stored in the repository. As the search is processed, related short-form videos are chosen based on the associations made to the investigated products or services. In embodiments, the list of related short-form videos can be optimized along multiple criteria. Along with the previously mentioned video metadata and machine learning data, the optimizing can include bids from advertisers or celebrity participation. The bids from advertisers can be ranked from high to low, resulting in videos with higher bids being included in those forwarded to the user more often. At least one related short-form video can be associated with each product or service search forwarded by the website.

Once the related short-form videos have been selected and optimized, a container unit is created on the website that generates the user search to view the videos. The videos play on the originating website dynamically, meaning that the videos can be viewed within the container unit without refreshing the surrounding webpage. The container unit can take several forms depending on the short-form video format and contents. Along with the short-form video container, a microsite, product card, or virtual product cart can be displayed on the website originating the search. These additional elements can show related information to the product being investigated by the user, such as pricing options, additional colors, accessories, suggested uses, etc. Sellers can also deploy these elements to make available promotional information or limited-time offerings. Product cards allow the seller to display a single page with all the relevant details about the product and an opportunity to purchase the item immediately. Microsites can contain multiple webpages with additional information, related products and services, unique sales opportunities, etc. A virtual product cart can be placed beside or on top of the video container unit, allowing the user an opportunity to purchase the item without leaving the originating website. The result is an enhanced ecommerce purchase opportunity for the product or service being researched by the user. These and other features of disclosed embodiments improve the technical field of ecommerce.

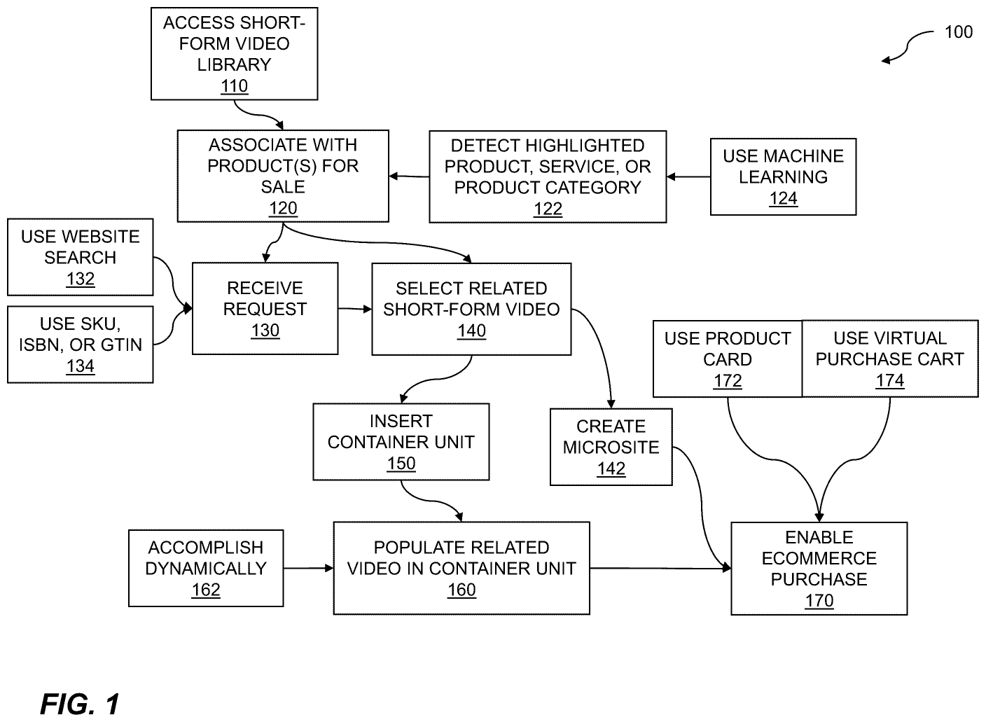

FIG. 1 is a flow diagram 100 for dynamic population of contextually relevant videos in an ecommerce environment. A library of short-form videos which provides content related to products and services for sale is accessed. Associations are formed between the videos and the products and services being offered for sale. As users on a website search for information on goods and services, the search details are passed to the server controlling access to the short-form video library. The search details can include user data and the SKU, ISBN, or GTIN number of the investigated product or service. Short-form videos related to the investigated product or service are selected based on the aforementioned associations. The selection process can be optimized based on metadata of the videos, bids from advertisers, celebrity participation, user data, and sales conversion rates. After related videos are selected, a container unit is inserted into the website which originated the search, and the videos are dynamically populated into the container. Along with the videos, a product card, vendor microsite, and virtual purchase cart can be inserted into the website, allowing the user to purchase the searched product or service. In embodiments, a product can refer to a product, service, or category of a product or service.

The flow 100 includes accessing a short-form video library 110 from a server. The library can include videos made by professionals, users, celebrity commentaries or testimonials, or a combination of sources. In embodiments, short-form videos in the library are associated with one or more products for sale 120. In some embodiments, the associating is made with a first product for sale. The associating can then go on to include a second product for sale. The associating includes relating one or more short-form videos within the library with at least one product for sale. The associating can be based on metadata from the short-form video, such as hashtags, repost velocity, user attributes, user history, ranking, product purchase history, view history, or user action. The metadata information can be used to rank the effectiveness of the video in leading to a product sale. The associating detects a product, service, or category highlighted in a selected video 122. For example, a video demonstration of an omelet pan can be associated with the omelet pan itself, a cooking class as a service, and the category of cooking utensils. The detecting can be based on machine learning 124. Machine learning can include user and conversion rate data for the videos in the library. User data from the website can be passed on to populate an order form or update metadata related to a viewed video. Metadata can be associated with short-form videos, including hashtags, repost velocity, user attributes, user history, ranking, product purchase history, view history, user actions, etc. For example, a video demonstrating the preparation of an omelet can include a hashtag for a particular restaurant, a chef who uses the omelet pan, or a retailer that sells the pan online. The metadata can be used to optimize the selection of related videos in later flow steps.

The flow includes receiving, from a website, a short-form video request 130. In embodiments, the request is made in response to a search 132 by a user for at least one product for sale. In some embodiments, the request identifies the product for sale with a stock-keeping unit (SKUs), International Standard Book Numbers (ISBNs), or Global Trade Item Numbers (GTINs) 134. For example, an omelet pan for sale may have an assigned SKU of 63600 on a particular vendor's website. The SKU number would be included in the search request made by the user from the website. If a purchase results as part of a later step in the flow, the SKU number can be used to update the seller's inventory. The flow includes selecting, from the library of short-form videos, at least one related short-form video 140, based on the associating 120. The selecting includes selection of the one or more short-form videos previously associated with the product for sale. In some embodiments, the optimizing is based on metadata. The metadata can include a creation date, geographic location, title, subject, host individual information, video resolution, video format, language, or other relevant information. In some embodiments, the optimizing is based on celebrity participation in at least one related short-form video, or on a bid from an advertiser. The videos are ranked in order of highest bid to lowest bid. In some embodiments, the optimizing is based on machine learning. Machine learning can be based on user data or conversion rate. For example, the video demonstrating the making of an omelet could include a well-known television chef. The metadata included with the video can include the creation date, location, title, language, and name of the chef doing the demonstration. The conversion rate can include the percentage of total views resulting in a sale of the omelet pan.

After the related videos have been selected and optimized, they are forwarded to the originating website for viewing. The flow includes inserting a container unit 150 into the website. In some embodiments, the container unit comprises a story block, carousel, floating player, or grid. Story blocks are stock-published video footage, templates, music, and photo content available for download from vendors. A carousel is a set of related containers within a primary container, each populated by a single related short-form video. A carousel container would allow multiple videos selected by the associations to be placed on the website in order of the optimizing. A floating player is a video player that runs entirely within the container unit without affecting the displayed main webpage. The container unit “floats” on top of the originating website page so that no format or content disruption occurs. A grid container allows elements to be placed in specific locations within the container using standardized row and column references. Header information, color schemes, company logos, etc., can thus be placed into the container unit in specific locations. The container unit is populated by the at least one related short-form video 160. In embodiments, the populating of the container unit is accomplished dynamically 162. Dynamic populating allows the container unit generated on the website to play the selected short-form video without refreshing the website page that sent the search request. In embodiments, a second container can be populated with the one or more short-form videos. This second container unit can be included in a second website that received a short-form video request based on a search for the previously mentioned second product for sale.

The flow includes enabling ecommerce purchasing 170. In some embodiments, the purchasing can be made within the container unit populated by the related short-form video. The ecommerce purchase may include a product card 172. A product card is a unique webpage for a specific item that explains its benefits. It can include an opportunity to purchase the item directly from the product card page. In some embodiments, a virtual purchase cart can be enabled 174. The virtual purchase cart can be displayed while the short-form video plays. It can overlay a portion of the related short-form video or appear on one side of the video container.

The flow can include creating a microsite 142. A microsite is a temporary website with multiple pages dedicated to a specific purpose independent of an organization's primary website. It has its own web address or uniform resource locator (URL), email address, content, and social media. The microsite can enable ecommerce purchasing of the product associated with the short-form video. For example, a user searching for omelet pans sees a short-form video on the website created by a famous chef. Another window containing the recipe for the omelet being made and links to additional recipes and demo videos also appears on the website. In the video's bottom corner, a clickable shopping cart appears, enabling the purchase of the omelet pan. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

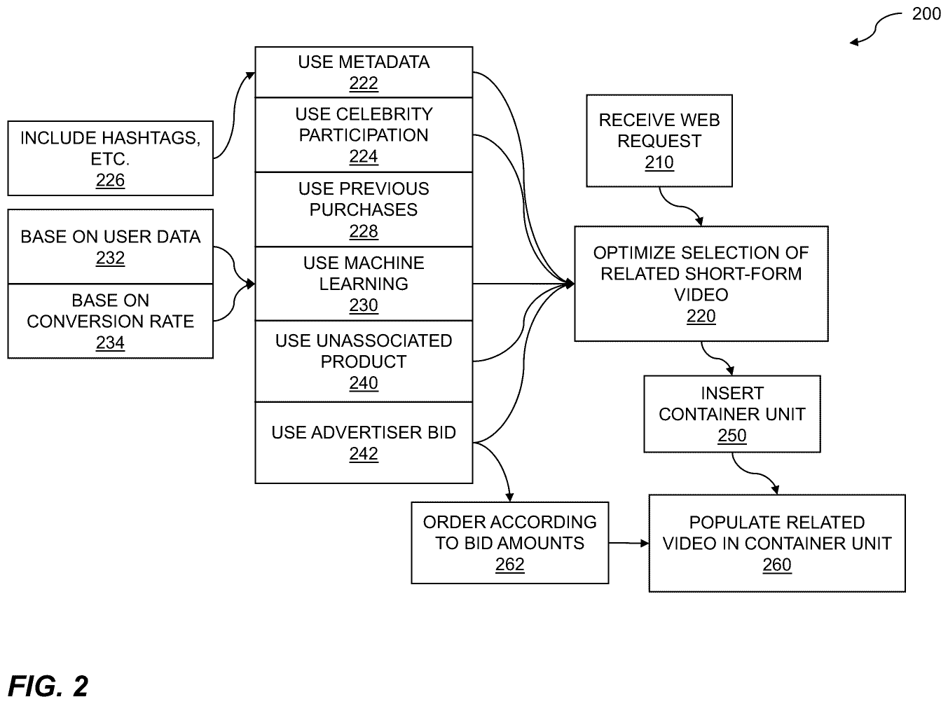

FIG. 2 is a flow diagram for optimizing the selection of contextually relevant videos in an ecommerce environment. As discussed above and throughout, a user search request is sent from a website to a server that accesses a library of short-form videos. Short-form videos in the library can be associated with products, product categories, or services for sale on the website. Short-form videos are selected from the library based on their association with the product or service being investigated by the website user. The short-form videos selected are optimized based on multiple criteria, including video metadata, celebrity participation in the video, machine learning techniques, bids from advertisers, user data, and conversion data. Bids from advertisers are used to optimize the related short-form videos by bid amount. In some embodiments, short-form videos of unassociated products can be included in response to a user search. A container unit is inserted into the website originating the search, and the selected short-form videos populate the container unit. The videos populate the container unit in the order determined by the optimizing process.

The flow 200 includes receiving a short-form video request in response to a search by a user for at least one product for sale on a website 210. In embodiments, the request can include user data that can be used later in the flow to populate a product card or virtual purchase cart. The user data can also be used to update metadata associated with the related short-form videos. In some embodiments, the search request can include stock-keeping unit numbers (SKUs), International Standard Book Numbers (ISBNs), or Global Trade Item Numbers (GTINs). The SKU, ISBN, or GTIN data can be used in later flow steps to update inventory data for a vendor selling the related product or service. In some embodiments, the search request can include user data such as name, address, phone number, credit card information, etc. This information can be passed to ecommerce options described in later figures to streamline the purchase process.

The flow 200 includes selecting and optimizing 220 one or more short-form videos related to the product or service included in the website search request 210. The optimizing can be based on multiple conditions, including metadata 222. The metadata associated with the short-form videos can include hashtags 226, repost velocity, user attributes, user history, ranking, product purchase history, view history, user actions, etc. Hashtags are used on blogging and photo-sharing sites to indicate cross-references by topic or theme. They are generally single words or short phrases starting with the pound sign (#) and are frequently used on social media sites to reference a keyword or topic in a user message, photo, or video. Repost velocity measures how rapidly a previously posted social media message, photo, or video is posted again by others, sometimes multiple times. It is reported in the number of reposts or shares per day. User attributes can include username, email address, location, etc. Ranking information can include the number of times a video has been viewed and how it compares to other videos of the same type, including the same product or service. User actions are logged events that can occur before or after viewing a short-form video. These actions can include other videos viewed; purchases completed, or started but not completed; etc. The metadata can identify short-form videos that closely relate to the web search request and are most likely to result in the purchase of a product or service.

The optimizing can include celebrity participation in the short-form video 224. Celebrity participation can be indicated in a caption associated with the video, in a metadata tag, in the video title, etc. Celebrity participation can positively impact prospective customers of a product or service, encouraging them to buy the product or service. It can also build brand awareness among potential customers and enhance the credibility of the product or service highlighted in the short-form video. In addition, celebrities with broad appeal can help to attract new customers toward a product, thus increasing sales. For example, a coffee company realized substantial growth in sales worldwide after George Clooney was featured in its video and print advertising campaigns, making its brand the fastest-growing business in 2010. User data can be updated to include celebrity information. This data can inform advertisers and sellers of a product or service. If a user is more likely to purchase a product associated with a particular celebrity, the advertiser can create more video content using the celebrity. The short-form video optimizing process can also be adjusted to rank more highly videos which feature a celebrity who is favored by a user. The optimizing can include using previous purchase history 228. Purchases, be they offline or online, can provide an indicator of interest. This interest can be used to select the related short-form videos.

The optimizing can include machine learning 230, based on user data 232 included in the website search request and on conversion rate data 234. User data 232 can include username, email address, location, gender, and so on. It can also include the number of times the user has visited a particular webpage or viewed a specific product or service. It can include credit card information, purchase history, color preferences, etc. Conversion rate data 234 indicates how often viewing a particular short-form video is associated with selling a product or service. A successful short-form video can have a conversion rate of seventy percent or higher. Machine learning techniques can use conversion rate and user data to help determine which short-form videos are more likely to result in an ecommerce purchase.

In embodiments, a user can search for an unassociated product for sale 240. The product or service category can be combined with other optimizing elements to select one or more short-form videos in response to the user search. In some embodiments, displaying one or more short-form videos to the user can increase the likelihood that the user will remain on the website and search for additional products, thus increasing the possibility of an ecommerce purchase. Web designers refer to the amount of time a user spends on a particular website as site stickiness. It is measured in the average minutes per month a user spends on a site. Selecting videos, even when the product being investigated is not directly associated, can increase the website's stickiness, thus increasing the possibility of a subsequent purchase.

In some embodiments, optimizing can include bids from advertisers 242 wherein the populating of related videos in the container unit 260 occurs in order of highest to lowest bid 262. There are several models for advertising bids on short-form videos. In some embodiments, advertisers are charged after fifty percent of their short-form videos are viewed for at least six seconds. Other models charge the advertiser after the first frame of the video is viewed. Others charge the advertiser only after the entire video has been viewed for at least three seconds. Regardless of the specific bidding model used, in embodiments, the more an advertiser pays per view, the higher the video is ranked in the optimizing process.

In embodiments, a container unit 250 is inserted into the website from which the search request was received. In some embodiments, the container unit comprises a carousel, story block, floating player, or grid. A carousel is a set of related containers within a primary container, each populated by a single related short-form video. A carousel container allows multiple videos selected by the associations to be placed on the website in order of the optimizing. Story blocks are stock-published video footage, templates, music, and photo content available for download from vendors. A grid container allows elements to be placed in specific locations within the container using standardized row and column references. Header information, color schemes, company logos, etc., can thus be placed into the container unit in specific locations. A floating player is a video player that runs entirely within the container unit without affecting the displayed main webpage. The container unit “floats” on top of the originating website page so that no format or content disruption occurs. Thus, the user can move the container unit around the screen as desired.

In embodiments, the container unit is populated by the related short-form videos in order of their optimizing. Optimizing the short-form videos allows the user to play the videos in the order that is most likely to lead to an ecommerce purchase of the researched product or service. Various steps in flow 200 may be changed in order, repeated, omitted, or the like without departing from the disclosed concepts. Various embodiments of the flow 200 can be included in a computer program product embodied in a non-transitory computer readable medium that includes code executable by one or more processors.

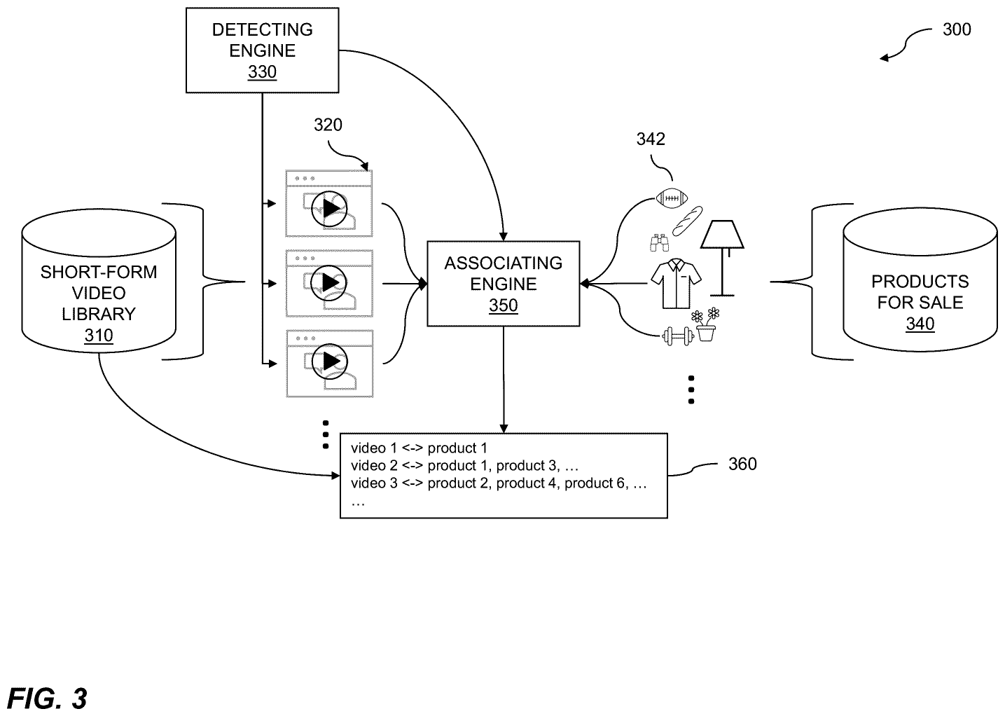

FIG. 3 is an infographic for associating short-form videos with products for sale. A library of short-form videos is accessed from a server. The short-form videos can include organic, sponsored, promotional, livestream, or livestream replay videos. A detecting engine identifies products, services, and categories (for products, services, etc.) highlighted in the short-form videos. The detecting process can be based on metadata associated with the videos, including title, subtitle, author, ratings, tags, date created, location, camera information, upload date, etc. Next, the server accesses a library of products and services for sale. The detected products, services, and categories from the short-form videos are associated with the products and services for sale. The associations are used in later steps to select short-form videos that satisfy a user request from a website for videos related to products for sale.

The infographic 300 can include a short-form video library 310. The short-form videos can include promoted, organic, sponsored, livestream, and livestream videos. Promoted videos are presented to viewers by third parties, celebrities, social media influencers, advertisers, product manufacturers, etc. They can be recommended to viewers as part of other forms of advertising or within other forms of media. Organic videos are made and shared using the free, built-in capabilities of a particular social media platform. Every social media platform has capabilities available to any user: posts, hashtags, likes, shares, etc. Videos shared with these built-in capabilities are part of the natural uses of the platform itself. Sponsored videos are purchased and directly associated with a particular organization, group, or individual. Livestream events are broadcast over the Internet for live viewing. These events are typically recorded for rebroadcast as stand-alone videos in complete or edited form. In some embodiments, metadata can be associated with short-form videos. The metadata can include creation date, geographic location, title, subject, host individual information, video resolution, video format, language, or other relevant information.

In embodiments, the short-form videos 320 are accessed, and the product, service, or category highlighted in the videos is determined by a detecting engine 330. In some embodiments, the detecting engine 330 can use the metadata associated with the short-form videos, including title, subtitle, author, ratings, tags, date created, location, camera information, upload date, etc. In addition, voice content can be analyzed for product references, and frame images can be scanned for product titles, brand names, etc. Machine learning can also be used to identify highlighted products and services within the videos. K-Nearest Neighbor algorithms, for example, can be instrumental in helping to determine product and service categories and classifying specific products and services. As the pool of short-form videos grows, the ability of the KNN machine learning process to determine products, services, and categories highlighted by the videos improves. In the infographic 300, the detected list of products, services, and categories associated with the short-form videos is sent to an associating engine 350.

The infographic 300 can include a database of products and services for sale 340. The list of products and services 342 is sent to the associating engine 350 and is combined with the list of short-form video products, services, and categories generated by the detecting engine 330. As the short-form video and “products for sale” databases grow, multiple associations are formed by the associating engine 350. The resulting list of short-form videos and associated products for sale can be stored for use in subsequent flow steps 360.

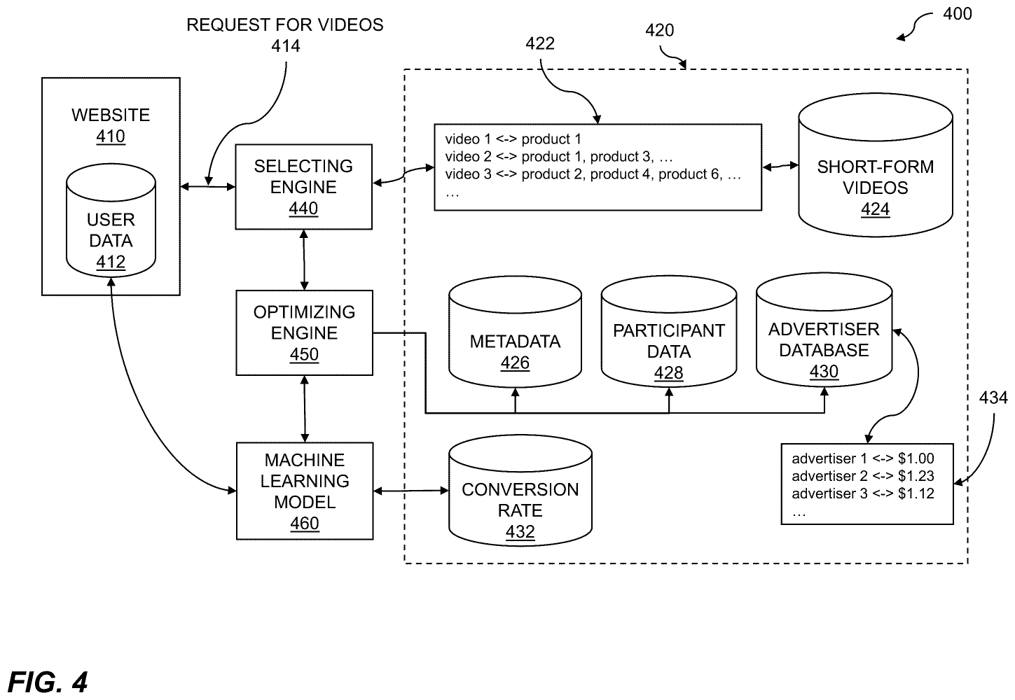

FIG. 4 is a block diagram for optimizing the selection of contextually relevant short-form videos. As a user initiates a search for information about a product or service for sale, a request is received from the website by a server accessing a database of short-form videos. The request from the website can include product identification data such as SKU, ISBN, GTIN, etc. The request can also include user data such as name, address, credit card information, previous purchases, etc. A selecting engine accesses the library of short-form videos and the list of associations with products and services for sale detailed in FIG. 2 above. A list of short-form videos associated with the product or service contained in the website request is generated and optimized. The optimizing engine sorts the list of short-form videos based on multiple data elements, including metadata, video celebrity participants, and advertising bids. A machine learning model records the optimized list of short-form videos. The machine learning model combines the selected short-form videos with website and user data and stores the information along with the outcome of purchasing choices made by the user in later flow steps. The conversion rate of the selected short-form videos becomes an element of metadata associated with the videos. It can be used to refine the list of videos selected in future user requests.

The block diagram 400 can include a website 410. In embodiments, the website can be a seller-hosted website, a social media platform, etc. A website user initiates a search request 414 for one or more short-form videos to be generated by the website and sent to a server with access to a short-form video library. In some embodiments, the user can actively generate the request by selecting a product or service for sale and searching for additional information. Alternatively, the request can be more passive as the website detects a user selecting videos or other site content that includes products or services for sale. The request 414 for videos can include data from the website and user data. The website data can include product information such as stock-keeping unit numbers (SKUs), International Standard Book Numbers (ISBNs), Global Trade Item Numbers (GTINs), etc. User information collected by the website originating the search can include the user's name, address, credit card, previous purchase history, etc. The website and user data can be forwarded to the selecting engine and the machine learning model for further processing in later flow steps.

The block diagram 400 can include several different databases 420 that can be used to select and optimize lists of short-form videos in response to user requests 414 forwarded from a website 410. In embodiments, the databases are used to choose short-form videos that inform the user about a product or service and increase the likelihood of an ecommerce purchase of the product or service being highlighted in the videos. The databases can include the library of short-form videos, metadata associated with the videos, celebrity participation, advertisers, advertiser bids for short-form videos, conversion rates, and previously detected associations between short-form videos and products and services for sale. In embodiments, a selecting engine 440 can be included. The selecting engine can select short-form videos from a library 424 via the list of associations 422 detected between the videos and products and services for sale. The detection of associations between the short-form videos and products for sale is discussed in FIG. 3 above.

The block diagram 400 can include an optimizing engine 450. In embodiments, the list of short-form videos associated with the product or service included in the request 414 for videos can be sorted based on multiple criteria. Metadata 426 from the short-form videos, participant data 428, and advertiser bids 430 can all be used to optimize the order of selected items. In some embodiments, metadata 426 from the short-form videos can include the title and subtitle of the video, author, production date, date posted, number of views, conversion rate, presenter, etc. These factors can influence the order in which the videos are presented to the user. For example, a video with a higher number of views or higher conversion rate can be moved up in the order of selected videos. Celebrity participation can be used as the participant data for optimization. Celebrity endorsements and brand ambassadors who sign on to promote a product exclusively can build trust and increase the reputation of a product or service. When celebrities endorse brands, they draw more attention to the advertiser and can significantly influence buyers' attitudes and purchase decisions. Their participation in short-form videos can bring credibility and positive attitudes toward the highlighted products, thus increasing the likelihood of purchases. This is especially true when the product or service is well matched to the celebrity endorser. Advertising bids in the advertiser database 430 with short-form videos can be purchased using several different buying models. In some embodiments, the advertiser is charged as soon as the first frame of the video is viewed. Other models only charge advertising fees once fifty percent of the video is in view for at least six seconds, after the entire video is in view for three seconds, etc. The advertiser bids 434 can be ordered from higher to lower, with the higher bids moving the associated video higher in the list of selected short-form videos.

The block diagram 400 can contain a machine learning model 460. In embodiments, the model can receive the optimized list of selected short-form videos and combine it with user data 412 from the website 410 that originated the request for videos. In later flow steps, the short-form videos are displayed to the website user in a container unit along with at least one method of completing an ecommerce purchase. The decision by the website user to purchase a product or service highlighted in one or more short-form videos can be recorded by the container unit and communicated to the machine learning model. Whether positive or negative, the purchase decision can be used to update conversion rate data 432 associated with the short-form videos displayed to the website user. The more often a video is associated with a favorable decision to purchase a product or service, the higher its conversion rate score. Therefore, short-form videos with higher conversion scores are more desirable to display to the website user. The conversion scores can be used by the optimizing engine 450 to rank the highest scoring videos higher in the list of videos sent to the container unit.

In embodiments, as short-form videos are added to the library 424 and viewed by website users, the videos that more often lead to user purchases can be identified and optimized. The factors that make a high conversion rate of short-form videos can be determined and used by advertisers, production companies, and influencers to develop more effective videos. Thus, the ecommerce environment is enhanced by optimizing the selection of contextually relevant short-form videos.

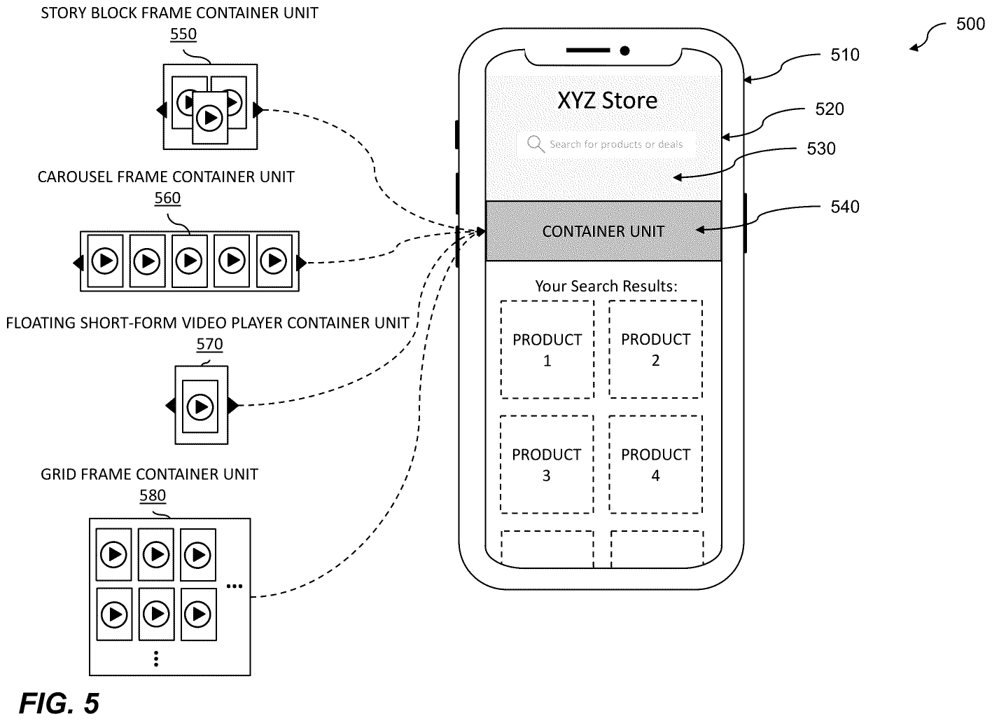

FIG. 5 is an infographic for populating a container unit with at least one related short-form video on a website. A user can request videos related to a product or service shown on a web site. The user can view the website on a cell phone, tablet, laptop, or desktop computer. The website can forward this request to a server with access to a library of short-form videos related to the products and services shown on the website. The website request can include data about the user, SKUs, ISBNs, GTINs, and metadata related to the selected product or service. The server accesses and selects short-form videos from the library based on stored associations made between the products and services and the videos. The related, selected videos are optimized based on metadata, celebrity participation, advertising bids, and conversion rates. A container unit is inserted into the originating website and populated with the optimized related short-form videos. The videos can be arranged in the container unit in a story block, a carousel, grid layouts, or in a floating video player. The container unit is populated dynamically within the requesting website, allowing the videos to display and play without refreshing the entire website.

An infographic diagram of a container unit on a website is shown 500. In some embodiments, a cell phone 510 can display a website 520 selected by a user to gather information about and purchase goods and services. The user can search for products on the website using a search option 530. The search can be forwarded to a server with access to a library of short-form videos highlighting products and services offered for sale on the website. In some embodiments, the search request can include data about the user such as name, address, credit card number, purchase history, etc. The search request can also contain information about the product or service included in the search, such as SKU, ISBN, GTIN, etc. The server can select short-form videos related to the products or services contained in the search query. In embodiments, the selected short-form videos can be optimized based on video metadata, celebrity participation, advertising bids, and conversion rates. A container unit 540 can be inserted into the website that sends the user search request. The container unit can be formatted in story block, carousel, floating, or grid formats. A story block frame container unit 550 arranges the optimized short-form videos within the container unit so that the highest scoring video is on top and obvious to the user, with the following highest scoring videos immediately beneath, and so on, down to the lowest scoring video. The optimizing score is based on the likelihood of the user purchasing the displayed product or service highlighted in the video. For example, a user may search for videos related to a cell phone. After accessing and searching the short-form video library, three videos related to the cell phone contained in the search request are selected. The selected videos can then be optimized based on metadata, celebrity endorsements, advertiser bids, and conversion rates. The video with the lowest score is placed into the empty container unit first, on the right side, followed by the middle scoring video on the left side. Finally, the highest scoring video is superimposed over the other two videos, partially covering them and centered in the container unit. Thus, the user naturally views the top video first, then the remaining videos from left to right.

A carousel frame container unit 560 arranges the optimized videos within the container so that the highest scoring video is farthest to the left, the next highest video immediately to the right of the first video, and so on. In some embodiments, the short-form videos can be arranged in a carousel to relate a story or narrative in order. This allows a user to view essential information related to a product or service first, followed by less important information, much in the same way that newspaper articles are written with the headline and leading paragraph containing the most vital details. A floating short-form video player container unit 570 places the highest scoring short-form video on top, with the next highest video immediately behind it, and so on. Only one video is visible at a time in a floating video player. In some embodiments, the floating video player container unit can be moved by the user to any section of the website, allowing the user to view other information or additional products or services while the videos are playing. A grid frame container unit 580 arranges the optimized videos in rows and columns, with the highest scoring video generally in the top left corner. The grid frame container allows videos and other related elements, such as banners, sale information, etc., to be placed in specific locations within the container using XY coordinates. This gives the advertiser or website designer flexibility when placing videos within the container unit based on screen size or other criteria.

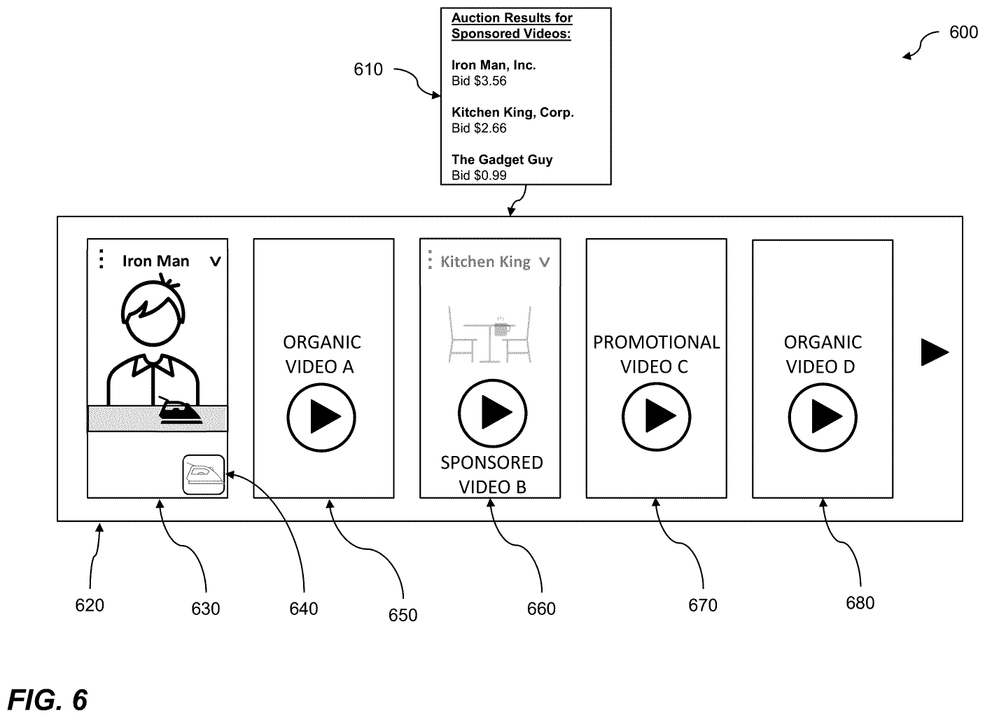

FIG. 6 is an infographic illustrating organic, sponsored, and promotional videos within a container unit prioritized by bid. A website that includes products and services for sale can be used to search for short-form videos that highlight the products and services being displayed or promoted. The search request can be received by a server accessing a library of short-term videos highlighting the products and services on the website. Short-term videos can be selected from the library based on detected associations between the videos and the product or service included in the search request. The videos can be organic, sponsored, or promotional in nature. Organic videos are created directly on a social media website using built-in capabilities available for free to any platform user: posts, hashtags, likes, shares, etc. Sponsored videos are purchased and directly associated with a particular organization, group, or individual, such as vendors, developers, advertisers, etc. Promoted videos are presented to viewers by third parties, celebrities, social media influencers, product manufacturers, etc. They can be recommended to viewers as part of other forms of advertising or within other forms of media. The selected short-term videos can be optimized based on video metadata, celebrity participation, conversion rates, and advertiser bids. Advertisers are charged fees when a website or web service plays short-form videos they sponsor. There are different models for the advertiser fees, based on how much video footage is viewed and how many seconds the viewer displays the video. Advertisers can bid on their sponsored videos to increase the chance that their short-form videos are played more often on a particular website or service—the higher the bid, the more likely the video will be played by the website.

An infographic diagram 600 to illustrate organic, sponsored, and promotional videos within a container unit prioritized by bid is shown. In embodiments, advertiser bids for sponsored videos 610 can be stored on a server with access to a library of short-form videos. The server can receive a user request for short-form videos related to a product or service shown on a website. Short-form videos highlighting the product or service included in the search request can be selected and placed into a container unit 620 on the user website. In some embodiments, the selected videos can be optimized based on video metadata, celebrity participation, conversion rates, and advertiser bids. In infographic 600, a user search request for a particular clothes iron can be received from a website. In some embodiments, organic, sponsored, and promotional videos can be selected by the server based on detected associations between the short-form videos and the clothes iron being investigated by the website user. The Iron Man, Inc. short-form video 630 and sponsored video B 660 from Kitchen King, Corp. can both have associated advertiser bids 610 recorded by the server. The bids can be received during an auction for sponsored videos. In infographic 600, the illustration shows Iron Man's highest bid of $3.56 per view of the short-form video they sponsored. Kitchen King has the next highest bid of $2.66 per view of their sponsored video. The Iron Man advertising bid places their sponsored video in the highest position of the optimized list of selected videos highlighting the clothes iron. In some embodiments, the first place ranking of the Iron Man video can be enhanced by placing a virtual purchase cart 640 in the lower right corner of the video. The purchase cart allows the user to immediately purchase the clothes iron or add the iron to a list of other products to be purchased later. Ecommerce options, including a virtual product cart, are discussed in more detail in later diagrams. The Kitchen King sponsored video B 660 is placed in the third position, lower than organic video A 650 and higher than the remaining selected video. Organic videos A 650 and D 680 show other users demonstrating the clothes iron. Both videos are developed and posted to the website using free features included on the site. Organic video A 650 includes a well-known TV interior decorator using the steam setting of the clothes iron to remove wrinkles from curtains just before a showing. Organic video D is made by a homeowner demonstrating the regular use of the clothes iron in everyday life. The celebrity participation in organic video A moves it higher in the optimized list of selected videos than organic video D. A promotional video produced by the manufacturer of the clothes iron is also included as video C 670. The promotional video can be produced by the manufacturer in a separate studio using professional cameras, lighting, sound, and narration. The resulting short-form video can be supplied to the library server with a standard fee charged each time the video is viewed. The specific contents of the video matching the product being searched by the website user rank the video higher than the organic video D 680, but lower than the organic video A that contains celebrity participation, and lower than the sponsored video B 660.

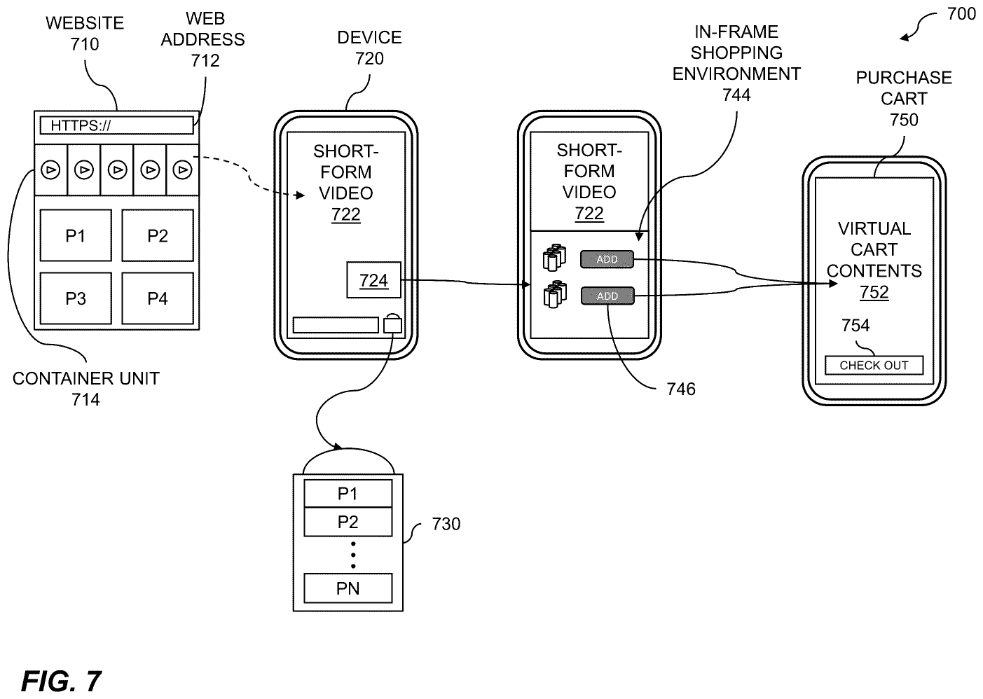

FIG. 7 shows product card and virtual purchase cart enablement for contextually relevant short-form videos. A web site user can submit a search for videos related to products or services shown on the website. A server with access to short-form videos can receive the search request and select one or more related videos based on associations made between the products and services for sale on the website and the videos. The selected videos can be placed in a container unit and inserted into the website originating the search request. The container unit can be inserted dynamically into the website so the videos can be viewed without refreshing the original website. In embodiments, the website and container unit can be viewed on a cell phone, tablet, laptop, or desktop computer. In some embodiments, a product card, microsite, or virtual purchase cart can be added to the container site to allow ecommerce purchases.

An infographic diagram 700 to show product card and virtual purchase cart enablement for contextually relevant short-form videos is shown. In the infographic 700, a website 710 can be viewed by a user on a cell phone, tablet, laptop, or desktop device 720. In embodiments, the internet browser displaying the website can display the web address 712 of the website near the top of the device screen. In some embodiments, the web address display area can be used to submit search requests by a user. As shown in earlier flow steps and figures, a user can submit a “search short-form video” request related to products and services displayed on the website. A server with access to a video library can receive the search request and select a list of contextually relevant short-form videos based on associations made between products for sale and the videos. The selected videos can be optimized based on video metadata, celebrity participation, advertiser bids, and conversion rates. The optimized list of selected videos can be displayed in a container unit 714 inserted into the website originating the search request. In embodiments, the short-form videos are displayed in the container unit dynamically, so that the website does not refresh as the videos play. In some embodiments, the container unit can arrange the optimized videos in a story block, carousel, floating player, or grid layout. The user can select a short-form video 722 in the container unit on the device 720 displaying the website.

In the infographic 700, an ecommerce purchase area 724 is included in the container unit with the short-form videos. In embodiments, the ecommerce purchase area can be a product card, microsite, or virtual purchase cart. A product card is a single webpage that displays product information including images, detailed descriptions, item numbers, prices, etc. It can include color, size, and quantity options. In embodiments, product cards include an option to purchase the displayed product directly or to add the product to a virtual purchase cart. A microsite is a small website with multiple pages limited to a specific group of products or services. In embodiments, a vendor or advertiser can create a microsite for temporary use without impacting their main business website. In some embodiments, a microsite can be created to highlight a sale campaign of a particular product or product family, display associated products or services, display additional information regarding the uses of a product, etc. A microsite can also include an option to purchase the displayed products or services or add the selected products to a virtual purchase cart. A virtual purchase cart can be displayed on top of a short-form video as it plays. It can collect items selected for purchase in a list 730 to be displayed and confirmed at a later time. In embodiments, the ecommerce purchase options can be expanded within the container unit as an in-frame shopping environment 744. Products and services selected for purchase in a product cart or microsite can be displayed in the shopping environment with the option to add items to the cart 746. When the user is ready to complete the purchase process, the purchase cart 750 can be expanded to display the virtual cart contents 752. The user can alter the quantities of items in the cart or remove them as desired. The user can check out 754, completing the purchase process. Thus, the selection and playing of contextually relevant short-form videos with ecommerce options included can enhance the sales opportunities of vendors and advertisers.

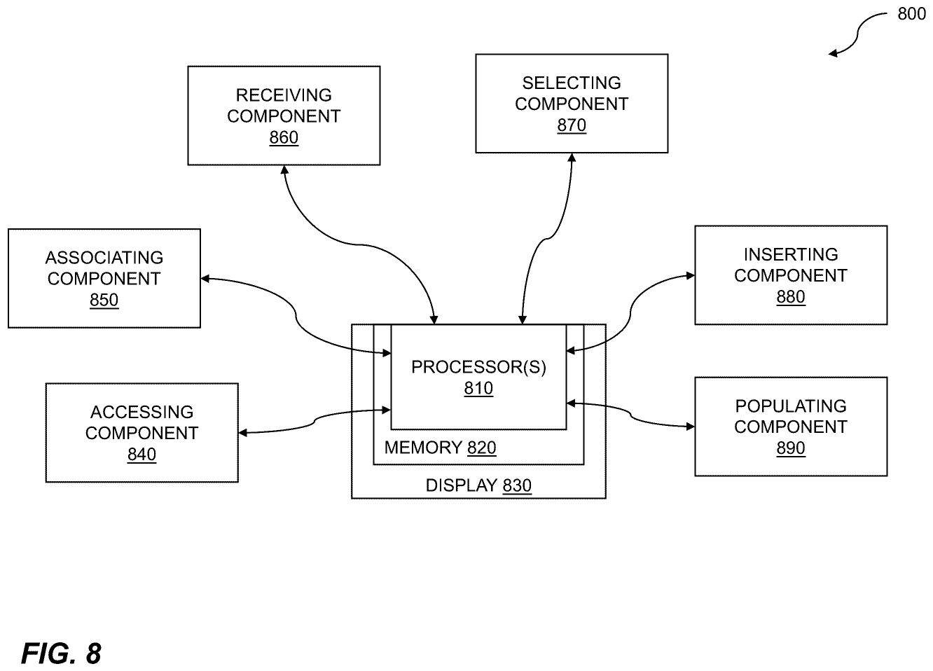

FIG. 8 is a system diagram for dynamic population of contextually relevant videos in an ecommerce environment. The system 800 can include one or more processors 810 coupled to a memory 820, which stores instructions. The system 800 can include a display 830 coupled to the one or more processors 810 for displaying data, video streams, videos, video metadata, product information, auction bid information, editing information, system logs, webpages, intermediate steps, instructions, and so on. In embodiments, one or more processors 810 are coupled to the memory 820 where the one or more processors, when executing the instructions which are stored, are configured to: access from a server a library of short-form videos; associate one or more short-form videos within the library with a product for sale; receive from a website a short-form video request, wherein the request is in response to a search by a user for the product for sale; select, from the library of short-form videos, at least one related short-form video, wherein selection is based on the association and wherein the at least one related short-form video includes the one or more short-form videos; insert a container unit into the website; and populate, in the container unit the at least one related short-form video, wherein populating is accomplished dynamically.

The system 800 can include an accessing component 840. The accessing component 840 can include functions and instructions for accessing one or more short-form videos from a short-form video library. The accessing component can utilize various application programming interface (API) functions for obtaining information from a short-form video library. The system 800 can include an associating component 850. The associating component 850 can include functions and instructions for associating one or more short-form videos with at least one product for sale. The associating can further detect that a product, service, or category is highlighted in the related short-form video. The detecting can be based on machine learning.

The system 800 can include a receiving component 860. The receiving component 860 can include functions and instructions for receiving from a website a short-form video request related to at least one product for sale. The website request is received in response to a search by a user for at least one product for sale. In some embodiments, the request can identify the product for sale with stock-keeping unit numbers (SKUs). The short-form video request can be implemented in response to a search for an unassociated product for sale. In some embodiments, the website is an application running on a mobile device.

The system 800 can include a selecting component 870. The selecting component 870 can include functions and instructions for selecting, from the library of short-form videos, at least one related short-form video, based on the associating. In embodiments, the selecting of the one or more related short-form videos is optimized. In some embodiments, the optimizing is based on metadata associated with the one or more short-form videos. The metadata can include hashtags, repost velocity (e.g., number of reposts per minute for a short-form video on a social media system), user attributes, user history, ranking, product purchase history, view history, and/or user actions. In some embodiments, the optimizing is based on a bid from an advertiser in order of highest bid to lowest bid. In some embodiments, the optimizing is based on celebrity participation in the one or more short-form videos. In some embodiments, the optimizing is based on machine learning. The machine learning can be based on user data and/or conversion rate data.

The system 800 can include an inserting component 880. The inserting component 880 can include functions and instructions for inserting a container unit into the website that sent the short-form video request. In embodiments, the container unit comprises a story block, carousel, floating pointer, or grid. Story blocks are stock published video footage, templates, music, and photo content available for download from vendors. A carousel is a set of related containers within a primary container unit, with each related container populated by a single selected short-form video. A floating player is a video player that runs entirely within the container unit without affecting the displayed main webpage. A grid container allows elements to be placed in specific locations within the container using standardized row and column references.

The system 800 can include a populating component 890. The populating component 890 can include functions and instructions for populating one or more related short-form videos into the container unit on a website. In embodiments, the populating is accomplished dynamically. Dynamic populating allows the container unit inserted on the website to play the selected short-form video without refreshing the website page that sent the search request. In some embodiments, the populating component 890 can generate a microsite based on the selected short-form videos. A microsite is a temporary website with multiple pages dedicated to a specific purpose independent of an organization's primary website. It has its own web address or uniform resource locator (URL), email address, content, and social media. The microsite can enable ecommerce purchasing of the product associated with the short-form video. In some embodiments, the populating component 890 can enable an ecommerce purchase within the one or more related short-form videos. The enabling can include a product card and/or a virtual purchase cart. The virtual product cart can display while the short-form video plays, and can cover a portion of the short-form video. As an example, the populating component 890 can populate a related short-form video for an omelet pan to a website that has a user searching for cooking pans. The first short-form video can include a demonstration of the omelet pan. The second related short-form video can include pricing and/or ordering information for the omelet pan. A microsite that includes the recipe for the omelet and/or information about the chef demonstrating the omelet pan can also be populated. As the video plays, a virtual cart can appear in a corner of the video where the user can purchase the omelet pan. In this way, disclosed embodiments provide automated, computer-implemented video processing techniques that utilize the ever-growing number of short-form videos for dynamic population of contextually relevant videos in an ecommerce environment. The short-form videos can be used for product promotion. Thus, disclosed embodiments enable new features for promotion of products, dissemination of information, and monetization of content.

The system 800 can include a computer program product embodied in a non-transitory computer readable medium for video processing, the computer program product comprising code which causes one or more processors to perform operations of: accessing from a server a library of short-form videos; associating one or more short-form videos within the library with at least one product for sale; receiving from a website a short-form video request, wherein the request is in response to a search by a user for the at least one product for sale; selecting, from the library of short-form videos, at least one related short-form video, wherein the selecting is based on the associating and wherein selection includes the one or more short-form videos; inserting a container unit into the website; and populating, in the container unit, the at least one related short-form video, wherein the populating is accomplished dynamically.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
accessing, from a server, a library of short-form videos;
associating one or more short-form videos within the library with a product for sale;
receiving, from a website, a short-form video request, wherein the request is in response to a search, by a user, for the product for sale;
selecting, from the library of short-form videos, at least one related short-form video, wherein the selecting is based on the associating and wherein the selecting includes the one or more short-form videos;
inserting a container unit into the website; and
populating, in the container unit, the at least one related short-form video, wherein the populating is accomplished dynamically.

2. The method of claim 1 further comprising optimizing the selecting of the at least one related short-form video.

3. The method of claim 2 wherein the optimizing is based on metadata.

4. The method of claim 2 wherein the optimizing is based on a bid from an advertiser.

5. The method of claim 4 wherein the optimizing occurs in order of highest bid to lowest bid.

6. The method of claim 2 wherein the optimizing is based on celebrity participation in the at least one related short-form video.

7. The method of claim 2 wherein the short-form video request is in response to a search for an unassociated product for sale.

8. The method of claim 7 wherein the optimizing is based on metadata, a bid from an advertiser, celebrity participation, or machine learning.

9. The method of claim 2 wherein the optimizing is based on machine learning.

10. The method of claim 9 wherein the machine learning is based on user data.

11. The method of claim 9 wherein the machine learning is based on conversion rate.

12. The method of claim 1 further comprising generating a microsite, wherein the generating is based on the selecting.

13. The method of claim 1 further comprising enabling an ecommerce purchase within the at least one related short-form video.

14. The method of claim 13 wherein the enabling includes a product card.

15. The method of claim 13 wherein the enabling includes a virtual purchase cart.

16. The method of claim 15 wherein the at least one related short-form video is displayed along with the virtual purchase cart while the at least one related short-form video plays.

17. The method of claim 15 wherein the virtual purchase cart covers a portion of the at least one related short-form video.

18. The method of claim 1 wherein the associating further comprises detecting that a product, service, or category is highlighted in the related short-form video.

19. The method of claim 18 wherein the product, service, or category is related to the product for sale.

20. The method of claim 1 wherein the associating is based on one or more hashtags.

21. The method of claim 1 further comprising associating the one or more short-form videos with a second product for sale.

22. The method of claim 21 further comprising populating a second container unit with the one or more short-form videos, wherein the second container unit is included in a second website that received a short-form video request based on a search for the second product for sale.

23. A computer program product embodied in a non-transitory computer readable medium for video processing, the computer program product comprising code which causes one or more processors to perform operations of:
accessing, from a server, a library of short-form videos;
associating one or more short-form videos within the library with a product for sale;
receiving, from a website, a short-form video request, wherein the request is in response to a search, by a user, for the product for sale;
selecting, from the library of short-form videos, at least one related short-form video, wherein the selecting is based on the associating and wherein selecting includes the one or more short-form videos;
inserting a container unit into the web site; and
populating, in the container unit, the at least one related short-form video, wherein the populating is accomplished dynamically.

24. A computer system for video processing, comprising:
a memory which stores instructions;
one or more processors coupled to the memory wherein the one or more processors, when executing the instructions which are stored, are configured to:
access, from a server, a library of short-form videos;
associate one or more short-form videos within the library with a product for sale;
receive, from a website, a short-form video request, wherein the request is in response to a search, by a user, for the product for sale;
select, from the library of short-form videos, at least one related short-form video, wherein selection is based on the association and wherein selection includes the one or more short-form videos;
insert a container unit into the website; and
populate, in the container unit, the at least one related short-form video, wherein populating is accomplished dynamically.
